(19) United States
(12) Patent Application Publication
(10) Pub. No.: US 2015/0263668 A1
(43) Pub. Date: Sep. 17, 2015

(54) SYSTEM AND METHOD FOR A PLUG AND PLAY ELECTRICAL WIRING HARNESS FOR THE CONNECTION OF A SOLAR SYSTEM TO EXISTING ELECTRICAL WIRING OF A BUILDING

(71) Applicant: Jon Dennis Sader, Franklin, MI (US)

(72) Inventor: Jon Dennis Sader, Franklin, MI (US)

(21) Appl. No.: 14/656,910

(22) Filed: Mar. 13, 2015

Related U.S. Application Data
(60) Provisional application No. 61/953,692, filed on Mar. 14, 2014.

(51) Int. Cl. H02S 40/34; H01R 13/64; H01B 7/00; H01R 4/24

(52) U.S. Cl. CPC H02S 40/34; H01R 4/2416; H01R 13/64; H01B 7/0045

(57) ABSTRACT

Provided is a system and method for a plug and play style electrical wiring harness permitting connection of a photovoltaic solar installation to existing electrical wiring of a building. Moreover, provided is a wiring bundle providing a plurality of electrically conductive wires in a pre-defined arrangement, the wiring bundle encased by a flexible non-conductive protective covering, the wiring bundle having a first end and a second end; a first electrical plug disposed upon the first end, the first electrical plug providing at least one connector for each of the of the plurality of conductive wires within the wiring bundle, the first electrical plug structured and arranged to connect to a connector provided by the photovoltaic solar installation in only one orientation, the orientation ensuring proper electrical connection and alignment between the output lines of the photovoltaic solar installation and the wires of the wiring bundle; and a second electrical plug disposed upon the second end of the wiring bundle, the second electrical plug providing at least one connector for each of the plurality of conductive wires within the wiring bundle, the second electrical plug having a male connector with a plurality of protruding electrical conductors for insertion into an existing building power outlet and a female connector with a plurality of inset electrical conductors to receive a conductor plug intended for the existing building power outlet to which the male connector of the second plug is attached.

### CROSS-REFERENCE TO RELATED APPLICATIONS

This application claims the benefit under 35 U.S.C. §119(e) of U.S. Provisional Application No. 61/953,692 filed Mar. 14, 2014 the disclosure of which is incorporated herein by reference.

### FIELD OF THE INVENTION

The present invention relates generally to the solar industry, and more specifically the residential photovoltaic solar installation, as a plug and play style electrical wiring harness permitting the home owner or installer to connect a photovoltaic solar installation to the existing electrical wiring of a building in much the same way as an appliance meeting safety and regulatory standards for electrical code and without the requirement of a third party electrician.

### BACKGROUND

With growing energy costs alternative energy sources are increasingly sought. This trend is present in both the commercial and residential environments. Solar energy has long been recognized as a possible green energy source for both the heating of water and the generation of electricity.

For energy production, photovoltaic cells grouped together as panels or modules are a common option. In general there are two types of solar installations, those that are commercial—being installed on a commercial building (business, apartment, etc.) or structure and those that are residential—being installed on a single-family house, townhouse, condo or the like.

Residential installations are typically smaller then commercial installations. As the residential home owner is also typically responsible for his or her household's electrical costs, he or she is directly aware of rising energy costs and is a viable candidate for the marketing of a solar installation to help reduce, if not eliminate, their current electrical bill. In addition, as most residential homes have roofs that are pitched, photovoltaic solar installations upon residential homes may be simpler then some commercial structures where typical flat roofs do not inherently angle the panels and the accumulation of snow and ice may be a factor.

In addition, in many communities across the United States, the number of residential houses is far greater then the number of commercial structures, making the residential photovoltaic solar market, although perhaps small on a house-by-house installation size, greater in aggregate then the commercial photovoltaic solar market.

Prices for the components of a solar installation continue to trend downwards, and although state, local and federal governments have continued to offer generous incentives most are scheduled to phase out or are reaching a point where their continuation will likely include a sunset component. Just the same, the needs for alternative energy continue to rise as the costs for more traditional energy production increase.

The typical residential photovoltaic solar system includes a number of different electrical components which are conceptually illustrated in Prior Art FIG. 1. As shown there is a simple house 100 having a roof 102. A plurality of photovoltaic panels 104 is installed upon the roof 102 where they collectively provide a photovoltaic solar field 106. In varying types of installations these panels 104 are interconnected and individually or in groups connected to one or more power inverters. For ease of illustration and discussion, it is assumed that each of panels 104 has a microinverter connected to the back, such that only interconnection cables 108 are shown interconnecting the panels 104.

A trunk line 110 then connects the panels 104 of the photovoltaic solar field 106 as a whole typically to a net meter 112 or revenue grade meter capable of determining and reporting how much electrical power has been generated by the photovoltaic panels of the installation. From the net meter 112 wiring typically continues to at least one disconnect device such as disconnect 114, and from there on to the house electrical panel 116. Within the house electrical panel 116, dedicated circuit breakers are installed and the electrical lines from the photovoltaic solar field 106 are then directly attached to the breakers and other typical components of the electrical panel 116.

As illustrated by dotted lines, typically there are a plurality of existing electrical circuits 118 within the house 100, which provide electricity to eclectically operated devices such as lights 120, and power outlets 122. As the photovoltaic solar field 106 is connected to the electrical panel 116, if and when the photovoltaic solar field 106 is generating power that power may well be supplied to the house 100 and its existing electrical circuits 118, but the photovoltaic solar field 106 is certainly not connected to any existing electrical circuit 118, or the existing wiring supporting such electrical circuits 118.

In a typical connection of a solar photovoltaic system to a buildings electrical system as provided by the electrical panel 116 the connecting wires are connected through generally a 30 AMP circuit breaker to the house system.

Proper wiring between these components is essential to the proper operation of the photovoltaic solar installation and it's ability to contribute electrical power to the residential structure and potentially the local power grid. Typically the wiring harness from the solar panels 108 to the meter 112, from the meter 112 to the disconnect 114 and from the disconnect 114 to the house electrical panel 116 are each comprised of four wires. Within the meter 112 and the disconnect 114 it is essential that the four wires are properly connected, for if wired incorrectly one or more elements may not work, the house 100 may receive no power from the photovoltaic solar field 106, and one or more elements including the panels 104 could potentially be damaged. Time and again, delays and additional costs are incurred with residential solar installations because wiring mistakes do occur.

With current installations the job of the certified electrician is to verify that these individual four wires have been routed correctly from the solar photovoltaic system to the electrical panel of the building. Moreover, he or she is simply ensuring that the wires are continuous in their respective paths—no crossing or misconnection having occurred.

Moreover, the configuration of a residential wiring system is important. Most residential structures have a plurality of different electrical circuits 118, such as the kitchen, master bedroom or bedrooms, living room, outside lights, laundry room, or the like. Each circuit in general has been established in accordance with electrical codes for a specific number of appliances and electrical amenities. At the present time, most of these electrical circuits are for 110 alternating current (AC), though in many cases at least one or two may also be for 220 AC so as to permit the homeowner to connect an electric stove, oven, dryer, air conditioner or other high current device.

Although electricians are often available to assist a home owner in the connection of one of these devices, the fact that these devices are manufactured and provided with an appropriate plug, or an appropriate plug can be acquired and attached by a competent individual, most of these devices are installed without the services of a certified electrician or permit issued by a governing body. These connections are nevertheless in compliance with local electrical code (if the appropriate plug has been used with the appropriate circuit), and at a substantial savings to what would otherwise be paid for the services of a certified electrician.

At the current time, the costs for residential photovoltaic solar installations include not only labor and parts for the installation itself, but there are also additional costs for permitting and the certification of the installation by a local electrician. As the photovoltaic solar installation is in essence a power generating station, the review and approval by a local certified electrician is generally required as the solar system is not installed in a manner that is easily integrated with existing residential wiring.

However, many certified electricians are not familiar with photovoltaic solar systems and he or she may therefore require additional training and time to understand the components of the system, their interconnections and the overall operation. This cost is not incurred by the electrician alone in the form of some further certification, but is most generally passed along to the home owner or party paying for the residential solar installation, and is therefore a factor in driving up, not down, the costs associated with a residential photovoltaic solar installation.

Moreover, the costs of a typical residential photovoltaic solar installation may be increased by hundreds, if not thousands, of additional dollars simply by requiring the involvement of a certified electrician. Additional delays in time, and ancillary costs may also be incurred when and where certified electricians are in short supply.

Hence there is a need for a method and system that is capable of overcoming one or more of the above identified challenges.

### SUMMARY

This invention solves the problems of the prior art by providing novel systems and methods for establishing a plug and play style electrical wiring harness permitting the home owner or installer to connect a photovoltaic solar installation to the existing electrical wiring of a building.

In particular, and by way of example only, according to one embodiment of the present invention, provided is a plug and play style electrical wiring harness permitting connection of a photovoltaic solar installation to existing electrical wiring of a building, including: a wiring bundle providing a plurality of electrically conductive wires in a pre-defined arrangement, the wiring bundle encased by a flexible non-conductive protective covering, the wiring bundle having a first end and a second end; a first electrical plug disposed upon the first end, the first electrical plug providing at least one connector for each of the of the plurality of conductive wires within the wiring bundle, the first electrical plug structured and arranged to connect to a connector provided by the photovoltaic solar installation in only one orientation, the orientation ensuring proper electrical connection and alignment between the output lines of the photovoltaic solar installation and the wires of the wiring bundle; and a second electrical plug disposed upon the second end of the wiring bundle, the second electrical plug providing at least one connector for each of the plurality of conductive wires within the wiring bundle, the second electrical plug having a male connector with a plurality of protruding electrical conductors for insertion into an existing building power outlet and a female connector with a plurality of inset electrical conductors to receive a conductor plug intended for the existing building power outlet to which the male connector of the second plug is attached.

In yet another embodiment, provided is a plug and play style electrical wiring harness connecting a photovoltaic solar installation to existing electrical wiring of a building, including: a wiring bundle providing a plurality of electrically conductive wires in a pre-defined arrangement, the wiring bundle encased by a flexible non-conductive protective covering having an alignment key; a first electrical plug disposed upon a first end of the wiring bundle in alignment with the alignment key, the first electrical plug structured and arranged to connect to a connector provided by the photovoltaic solar installation, the alignment with the alignment key ensuring proper electrical connection and alignment between output lines of the photovoltaic solar installation and the wires of the wiring bundle; and a second electrical plug disposed upon a second end of the wiring bundle in alignment with the alignment key, the second electrical plug providing at least one connector for each of the plurality of conductive wires of the wiring bundle, the second electrical plug having a male connector with plurality of protruding electrical conductors for insertion into an existing building power outlet and a female connector with a plurality of inset electrical conductors to receive an electrical plug intended for the existing building power outlet to which the male connector of the second plug is attached.

For still yet another embodiment, provided is a plug and play style electrical wiring harness connecting a photovoltaic solar installation to existing electrical wiring of a building, including: at least a first, second and third wiring bundle each providing a plurality of electrically conductive wires in a pre-defined arrangement, each wiring bundle encased by a flexible non-conductive protective covering having an alignment key; a first electrical plug disposed upon a first end of the first wiring bundle in alignment with the alignment key, the first electrical plug structured and arranged to connect to a connector provided by the photovoltaic solar installation, the alignment with the alignment key ensuring proper electrical connection and alignment between output lines of the photovoltaic solar installation and the wires of the first wiring bundle; and a second electrical plug disposed upon a second end of the first wiring bundle in alignment with the alignment key, the second electrical plug providing at least one connector for each of the plurality of conductive wires of the first wiring bundle, the second electrical plug structured and arranged to connect to a first connector of a meter; a third electrical plug disposed upon a first end of the first wiring bundle in alignment with the alignment key, the third plug providing at least one connector for each of the plurality of conductive wires within the second wiring bundle, the third electrical plug structured and arranged to connect to a second connector of the meter; a fourth electrical plug disposed upon a second end of the second wiring bundle in alignment with the alignment key, the fourth plug providing at least one connector for each of the plurality of conductive wires within the second wiring bundle, the plurality of electrical plugs structured and arranged to connect to a first connector of a disconnect; a fifth electrical plug disposed upon a first end of the third wiring bundle in alignment with the alignment key, the fifth plug providing at least one connector for each of the plurality of conductive wires within the third wiring bundle, the fifth electrical plug structured and arranged to connect to a second connector of the disconnect; and a sixth electrical plug disposed upon a second end of the third wiring bundle in alignment with the alignment key, the sixth plug providing an electrical plug having a male connector with a plurality of protruding electrical conductors for insertion into an existing building power outlet and a female connector with a plurality of inset electrical conductors to receive a plug intended for the existing building power outlet.

Further, in yet another embodiment, provided is a plug and play style electrical wiring harness kit permitting connection of a photovoltaic solar installation to existing electrical wiring of a building, including: a wiring bundle providing a plurality of electrically conductive wires in a pre-defined arrangement, the wiring bundle encased by a flexible non-conductive protective covering, the wiring bundle having a first end and a second end; a first electrical plug to be disposed upon a first end of the wiring bundle in a pre-determined alignment, the first electrical plug providing at least one connector for each of the of the plurality of conductive wires within the wiring bundle, the first electrical plug structured and arranged to connect to a connector provided by the photovoltaic solar installation in only one orientation, the orientation ensuring proper electrical connection and alignment between the output lines of the photovoltaic solar installation and the wires of the wiring bundle; and at least one second electrical plug to be disposed upon a second end of the wiring bundle in a pre-determined alignment, the second electrical plug providing at least one connector for each of the plurality of conductive wires within the wiring bundle, the second electrical plug having a male connector with plurality of protruding electrical conductors for insertion into an existing building power outlet and a female connector with inset electrical conductors to receive a plug intended for the existing building wire power outlet.

### BRIEF DESCRIPTION OF THE DRAWINGS

At least one method and system for establishing a plug and play style electrical wiring harness permitting the home owner or installer to connect a photovoltaic solar installation to the existing electrical wiring of a building will be described, by way of example in the detailed description below with particular reference to the accompanying drawings, and:

FIG. 1 is a conceptual illustration of a Prior Art building photovoltaic solar installation;

FIG. 2 is a conceptual illustration of a plug and play electrical wiring harness for the connection of a solar system to existing electrical wiring of a building according to an embodiment of the present invention;

FIG. 3 is a partially enlarged cross section of wiring bundles with alignment keys according to at least one embodiment of the present invention;

FIGS. 4A-4D are conceptual illustrations of the press fit connections between various plugs and wiring bundles according to at least one embodiment of the present invention;

FIGS. 5A-5D are conceptual illustrations of the press fit connections for the plug intended for connection to an existing outlet and a wiring bundle according to at least one embodiment of the present invention;

FIG. 6 is a conceptual exploded overview of the plug and play wiring harness according to an embodiment of the present invention;

FIG. 7 is a conceptual overview of the plug and play wiring harness as connected among its various components according to an embodiment of the present invention;

FIGS. 8A-8B are a conceptual view illustration demonstrating variations of the plug end for connection to an existing outlet following introduction of the wiring bundle through a hole in the wall appropriately sized for the wiring bundle according to an embodiment of the present invention.

### DETAILED DESCRIPTION

Before proceeding with the detailed description, it is to be appreciated that the present teaching is by way of example only, not by limitation. The concepts herein are not limited to use or application with a specific system or method for a plug and play style electrical wiring harness permitting connection of photovoltaic solar installation to existing electrical wiring of a building.

Existing electrical wiring of a building as used herein is understood and appreciated to be the existing wiring providing electrical circuits throughout the house and not merely the wiring terminating in one or more existing circuit breaker boxes. Moreover, the existing electrical wiring is understood and appreciated to provide user operable outlets to which a user may connect an electrical appliance at his or her discretion and without requiring the assistance of a certified electrician.

Indeed, as is further understood from the following description and accompanying materials, the connection of the solar photovoltaic installation is performed with the present invention in substantially the same way as a user might connect an appliance such as a stove, oven, air conditioner or electric dryer.

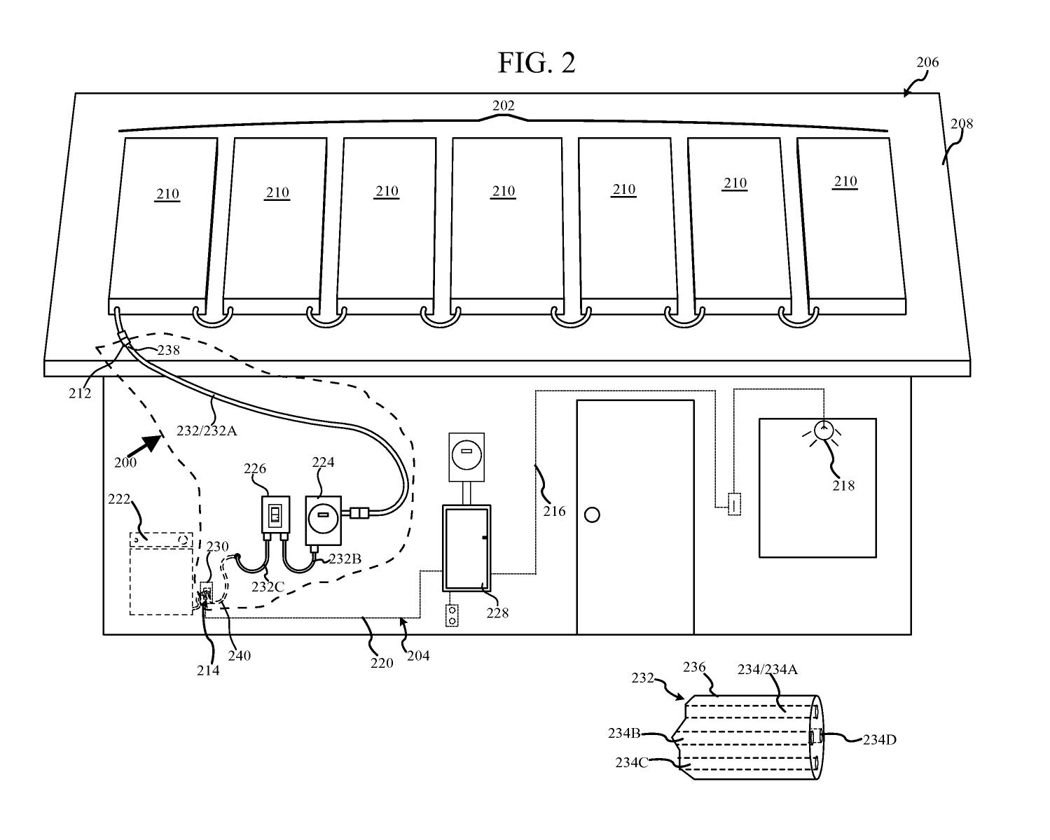

Moreover, as is conceptually shown in FIG. 2, according to at least one embodiment of the present invention, provided is a plug and play style electrical wiring harness 200 permitting connection of a photovoltaic solar installation 202 to the existing electrical wiring 204 of a building 206.

More specifically, as shown in FIG. 2, the conceptual building 206 has a roof 208, and a plurality of photovoltaic solar panels 210 installed thereon and collectively providing a photovoltaic solar field 202, also referred to as a photovoltaic solar installation.

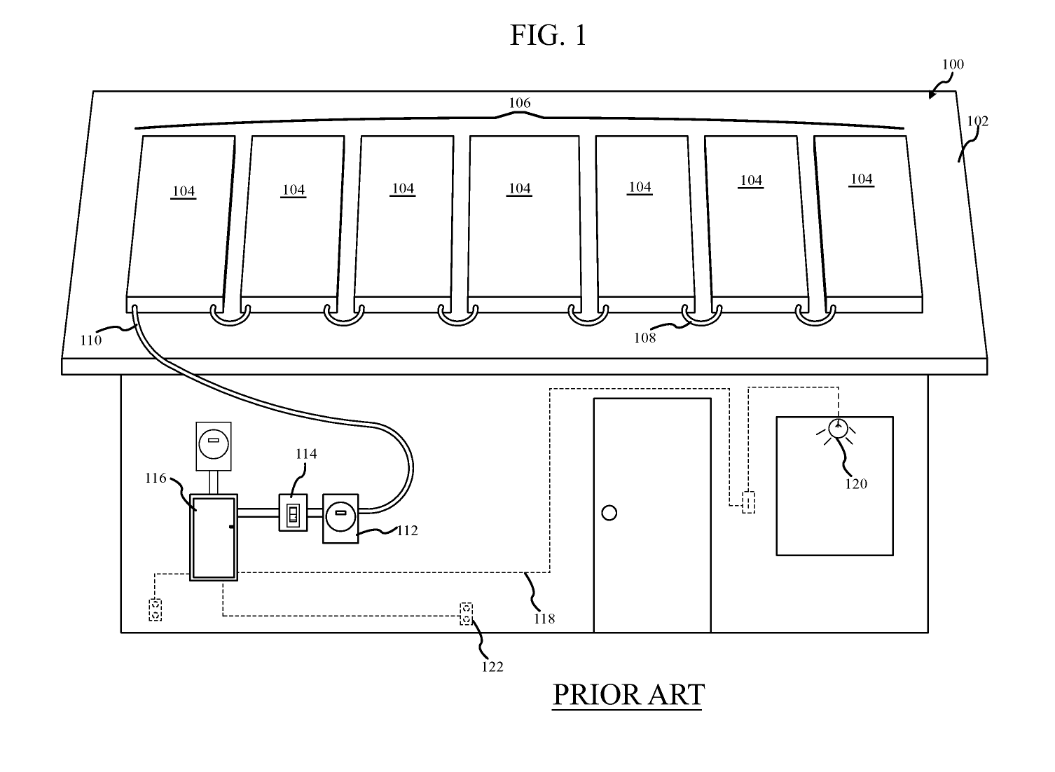

In sharp contrast to FIG. 1, and as is further described below, in FIG. 2 the wiring harness 200 from the solar installation 202 to the existing electrical wiring 204 is achieved with plugs, of which plug 212 to the photovoltaic solar field 202 and plug 214 to the existing electrical wiring 204 are exemplary.

Moreover, the present invention may be generally summarized as a plug-and-play wiring harness 200 for connecting a photovoltaic solar field 202 to existing electrical wiring 204. Plug-and-Play is a term generally understood to mean, “plug in and use” without further configuration or user adjustment. With respect to the wiring harness 200, plug-and-play is of course understood and appreciated to convey that the wiring harness 200 addresses the basic issues of connection without requiring adjustment or the involvement of a certified electrician.

Existing electrical wiring 204 is understood and appreciated to be the wiring within the walls of the building. This wiring provides the distinct circuits that are controlled by the electrical junction panel 228 of the building, and more specifically the circuit breakers thereof. Moreover it is the existing electrical wiring 204 and specifically exemplary circuit 216 that enables a person to activate a light 218, and likewise exemplary circuit 220 that enables a person to use an electrical dryer 222 to dry clothes.

Moreover, although the electrical panel will of course have existing wires terminating at various circuit breakers within the electrical panel, these terminating wire ends are understood and appreciated to be the end of specific circuits and are not considered to be the existing electrical wiring 204 within the walls that a person enjoys access to by way of one or more plug outlets throughout the house. Moreover, when connecting a new electrical appliance a user does not venture out to the electrical panel to hard wire connect the new device, but rather uses an existing outlet of the existing electrical wiring 204 to “plug in” the new device and enjoy the use thereof.

As indicated by FIG. 1, all associated elements of the wiring harness 200, such as net meter 224 and disconnect 226 are pre-established components so as to thereby ensure that the wiring orientation remains consistent and as intended from the so photovoltaic solar field 202 to the point of connection to the existing electrical wiring 204.

It is to be understood and appreciated that existing electrical circuits for homes and buildings are generally designed with a maximum current draw. If the current drawn through the circuit exceeds the intended draw, an interruption device, such as a circuit breaker, will trip as a safety measure. With respect to the present invention, it is to be understood and appreciated that a solar photovoltaic installation is not a high current appliance. Rather, it is a system that drives power into the house electrical system. One or more devices of the solar photovoltaic installation, such as the net meter 224 (the device which monitors how much power is provided) may indeed draw power from the house to maintain minimal levels of operation, but such current draw is minimal—such as a trickle charge, and a negligible factor in terms of overall circuit load.

As noted above, in a typical connection of a solar photovoltaic system to a buildings electrical system, the connecting wires are run to the buildings electrical junction panel where the wires are connected through generally a 30 AMP circuit breaker to the house system.

The novel and advantageous nature of the present invention plug and play wiring harness 200 is that the connection of the photovoltaic solar field 202 to the existing electrical wiring 204 of the building 206 is functionally the same as if the photovoltaic solar field 202 was connected directly to the electrical junction panel 228, but the connection is instead made at an existing outlet, such as outlet 230 provided by exemplary pre-existing circuit 220. Moreover, as the connection point is made via an existing outlet 230 provided by the existing electrical wiring 204, the connection is an act that may be performed by the home owner or system installer and does not require the assistance of a certified electrician.

To briefly summarize, provided is a system and method that permits rapid installation of and connection of a solar photoelectric installation, i.e., a photovoltaic solar field 202, to existing electrical wiring 204 of a building such as a building 206.

For at least one embodiment, the wiring harness 200 is provided by at least one wiring bundle 232 that provides a plurality of electrically conductive wires 234 that are electrically isolated from each other within a non-conductive protective covering 236. As shown, for at least one embodiment, wiring harness 200 has three wiring bundles—wiring bundle 232A running from the photovoltaic solar field 202 to the meter 224, wiring bundle 232B running from the meter 224 to the disconnect 226, and wiring bundle 232C running from the disconnect to plug 214 for connection to existing outlet 230.

Of course, for varying embodiments where the inverters of the photovoltaic solar field 202 are mounted on side of the building 206, or it is desirable to provide an extra outlet such as for charging a battery powered vehicle, wiring harness 200 may include additional elements and or wiring bundles 232.

For at least one embodiment, wiring bundle 232 provides four conductive wires 234A, 234B, 234C and 234D. For at least one alternative embodiment, wiring bundle 232 provides three conductive wires 234, such as just 234A, 234B, and 234C. And for yet another embodiment, wiring bundle 232 provides five conductive wires 234, not shown, and or a specifically dedicated grounding wire, not shown.

As is further set forth below, and shown in the enlarged section of wiring bundle 232, within the covering 236, the arrangement of the plurality of conductive wires 234 is pre-defined so that the location of each wire 234 can be determined without unwrapping the protective covering 236. Moreover, the covering 236, and or the overall wiring bundle 232 itself provides at least one alignment key as is further discussed below. The protective covering 236 is non-conductive, waterproof, and resistant to UV, heat and other environmental factors.

A first plug 212 at the first end of the wiring harness 200 is structured and arranged to couple with the existing and expected types of plugs as provided by a photovoltaic solar field 202, or as may be attached to a photovoltaic solar field 202 if not otherwise provided.

The second plug 214 is structured and arranged to be received by an existing outlet 230 within the building, i.e. building 206, such as an existing 220 A/C outlet such as may be provided for a dryer, stove, oven, air conditioner or other electrical device. For at least one embodiment, the second electrical plug 214 has a male connector with protruding electrical conductors for insertion into an existing power outlet and a female connector with inset electrical conductors to receive a plug intended for an existing building power outlet.

As noted above, for at least one embodiment, the plug and play wiring harness 200 also provides at least one electrical device such as a power meter 224 and electrical disconnect 226 as integral components pre-wired between the first plug 212 and the second plug 214. In varying embodiments it is understood and appreciated that additional electrical devices such as but not limited to a roof top disconnect, battery storage system, additional meter or reporting device or other electrical device may be disposed as a component of the wiring harness 200.

Moreover, each electrical device in the wiring harness 200 is itself fitted with plug and play plugs that can only receive the interconnecting wiring bundle in one orientation which has been predefined. More specifically, for at least one embodiment the wiring meter 224 and disconnect 226 are pre-wired and provided as installation components of the wiring harness 200, the prewired meter 224 and disconnect 226 providing pre-established plugs that will only couple with the correct plugs of wiring bundles 232 intended for proper interconnection, further advantageously ensuring that proper wiring is maintained throughout the wiring harness 200.

As such, as the meter and disconnect are pre-wired and certified with plug and play plugs of their own, the field installer or home owner is assured that interconnection of the components can only be performed in one way. In addition, for at least one embodiment the pre-wiring and receiving plug confirmation of each electrical device in the wiring harness 200 such as the meter 224 and disconnect 226 may be UL certified. More specifically, wiring harness 200 advantageously ensures that in addition to plug and play alignment certainty in connecting the photovoltaic solar field 202 to existing outlet 230 provided by existing electrical wiring 204 each electrical device component of the wiring harness 200 also advantageously provides plug and play alignment certainty which is pre-established and may be pre-certified by state, federal or local authorities who are concerned with or otherwise regulate electrical systems.

The present invention advantageously overcomes and removes these wiring concerns by ensuring that the wiring harness can be connected in only one way between the photovoltaic solar field 202 and an existing outlet 230 and existing electrical wiring 204 of a building such as a building 206.

A key element of the present invention is the ability to provide a plug and play wiring harness 200 appropriate to a variety of different building and photovoltaic solar field 202 installations. Moreover, although the wiring harness 200 can be pre-assembled and delivered to an installation site for use, more commonly it will be desirable to have a wiring harness 200 of the proper length so that excess slop in the plug and play wiring harness 200 is avoided. In short, for at least one embodiment it is desirable for at least at least one wiring bundle 232 to be customizable in length, i.e., it can be cut. The plug for one end may be pre-established or both may be field installed—however it is important to understand and appreciate that the present invention provides a means for ensuring proper alignment of the wires 234 in the wiring bundle 232 as they are connected to each plug.

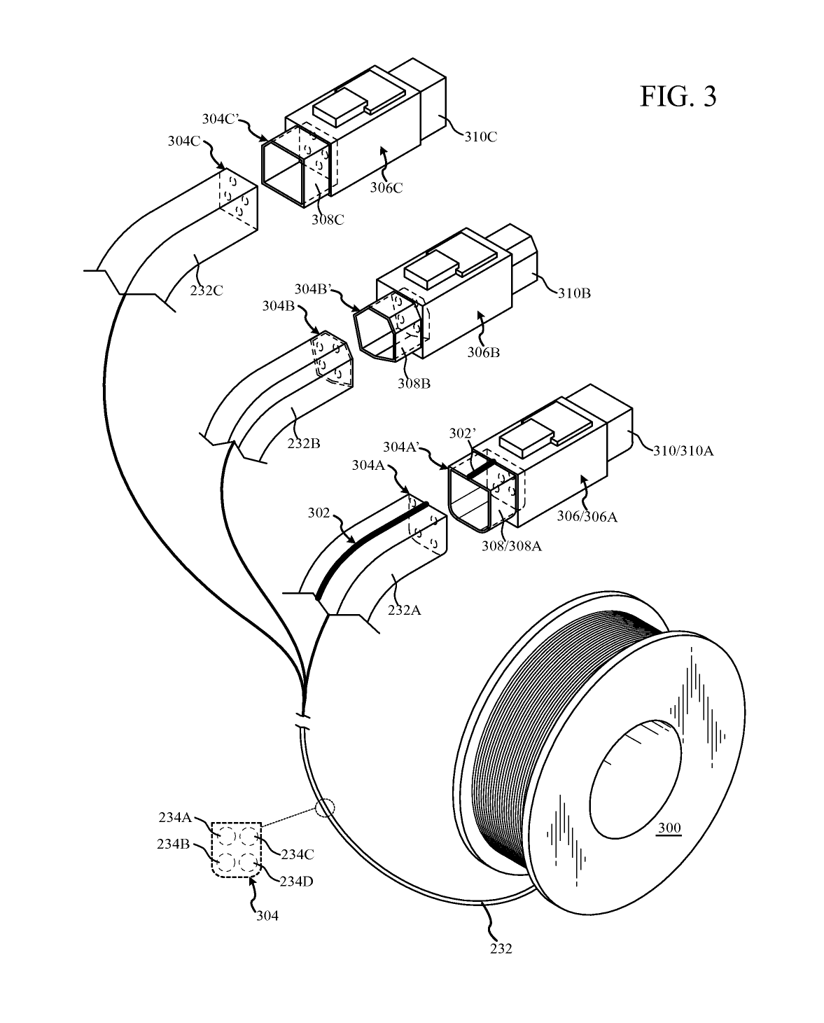

To ensure this, for at least one embodiment the wiring bundle 232 providing each section of the wiring harness 200 provides an alignment key as is shown in FIG. 3.

As shown in FIG. 3, a spool 300 provides a generally continuous length of wiring bundle 232. For at least one embodiment this is a visual indicator 302, such as a line, stripe or other visually apparent element. In addition, for at least one embodiment the alignment key is a physical key. More specifically the cross section 304 of the wiring bundle 232 has a specific and pre-defined geometric shape that is not symmetrical. As shown in dot relief for cross section 304, the locations of wires 234A, 234B, 234C and 234D remain the same along the length of wiring bundle 232.

The advantageous plugs 306, such as plug 212 in FIG. 2 now shown in greater detail as plug 306A used in the wiring harness 200 mirror this non-symmetrical cross section 304, such that they may only be disposed upon an end of the wiring bundle 232 in one way. Visual indicators 302 and physical keys 304 may of course be combined.

Moreover in FIG. 3, exemplary wiring bundle 232A is shown to have a cross section 304A appearing as a square with a rounded bottom. Correspondingly, exemplary plug 306A has a receiver section 308A for wiring bundle 232A with substantially the same cross section 304A′. Plug 306 also has a connection end 310 which is structured and arranged to connect in a predefined orientation to an intended mating plug, such as for example a plug attached to the photovoltaic solar field 202 or a plug attached to meter 224.

As is further suggested by FIG. 3, for at least one embodiment, each of the wiring bundle sections, i.e., wiring bundles 232A, 232B and 232C, of wiring harness 200 has a different cross section—wiring bundle 232B having cross section 304B and wiring bundle 232C having cross section 304C. Each of these cross sections mates with a corresponding receiver section 308B/308C of a corresponding plug 306B′/306C′.

As such, during fabrication of each wiring bundle 232, i.e. wiring bundles 232A, 232B, and 232C the installer can be assured that he or she is assembling each wiring bundle 232 for its specific location and interconnection within wiring harness 200.

As each of these three cross sectional profiles may be different, the wiring harness yet further advantageously ensures proper interconnection of the elements of the wiring harness. Moreover, with such a configuration of different wiring bundles 232, the photovoltaic solar field 202 can only be connected to the power meter 224, the power meter can only be connected to the electrical disconnect 226 and the electrical disconnect can only be connected to the existing outlet 230.

For at least one embodiment, the plugs 306 are commercially available plugs as provided by Molex® as part of their sealed connector system MX150L. The MX150L sealed connector system has been designed to meet the needs for a rugged environmentally sealed connector system. These mat-sealed connectors are based upon 1.5 and 2.5 mm blade-type terminals. This design eliminates the need to purchase, handle and crimp individual wire seals. Moreover, one plug may be fit to multiple wires—i.e., four wires in one process of connection/attachment.

Assembly of each wiring bundle and end plug set is typically understood and appreciated to be accomplished by press fit and crimping methods, though a variety of other methods may be employed as may be desired for specific embodiments and or locations of use of wiring harness 200.

To summarize, and with respect to FIG. 2, for at least one embodiment provided is a plug and play style electrical wiring harness 200 permitting connection of a photovoltaic solar field 202 to existing electrical wiring 204, including: a wiring bundle 232 providing a plurality of electrically conductive wires 234 in a pre-defined arrangement, the wiring bundle 232 encased by a flexible non-conductive protective covering 236, the wiring bundle 232 having a first end 238 and a second end 240. A first electrical plug 212 disposed upon the first end 238. The first electrical plug 212 providing at least one connector for each of the of the plurality of conductive wires within the wiring bundle 232. The first electrical plug 212 is also structured and arranged to connect to a connector provided by the photovoltaic solar field 202 in only one orientation, the orientation ensuring proper electrical connection and alignment between the output lines of the photovoltaic solar field 202 and the wires 234 of the wiring bundle 232. A second electrical plug 214 is disposed upon the second end 240 of the wiring bundle 232, the second electrical plug 214 providing at least one connector for each of the plurality of conductive wires 234 within wiring bundle 232, the second electrical plug 214 having a male connector with a plurality of protruding electrical conductors for insertion into an existing outlet 230 and a female connector with a plurality of inset electrical conductors to receive a conductor plug intended for the existing outlet to which the male connector of the second plug is attached. Further embodiments of wiring harness 200 may also include additional components such as but not limited to, at least one meter 224, at least one disconnect 226, additional plugs, and varying wiring bundles 232 having different alignment keys.

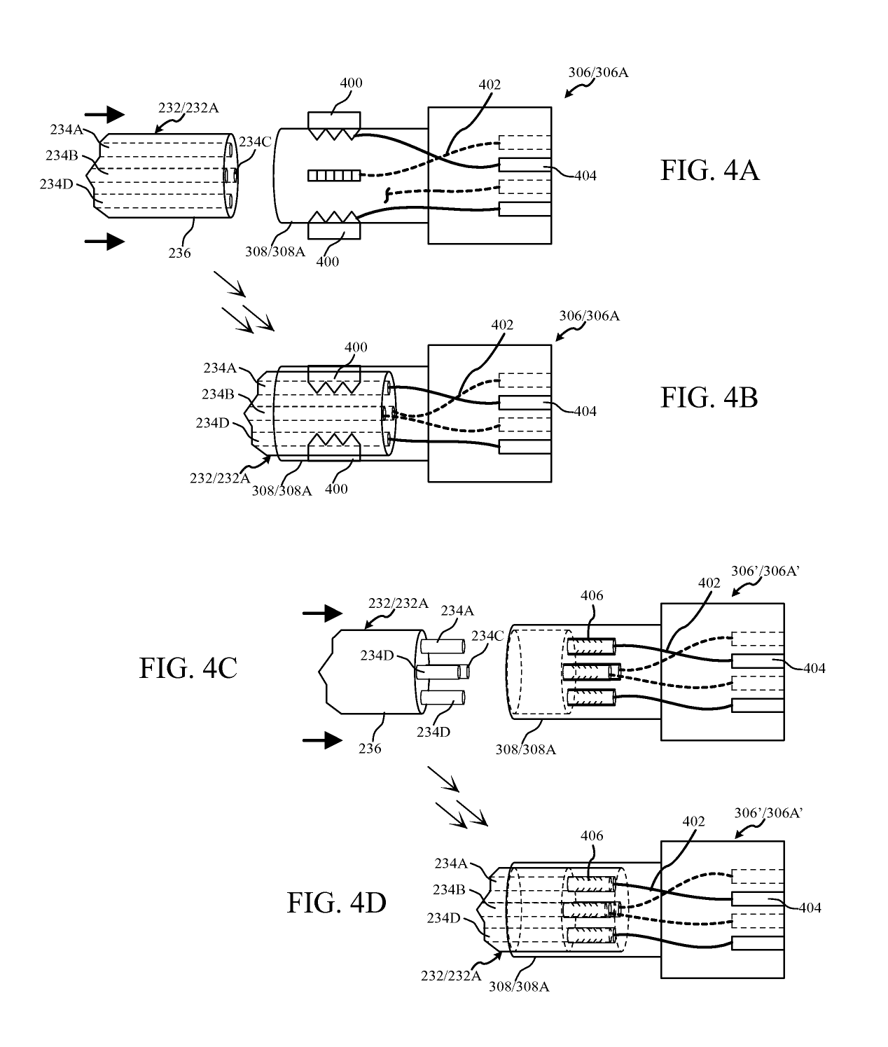

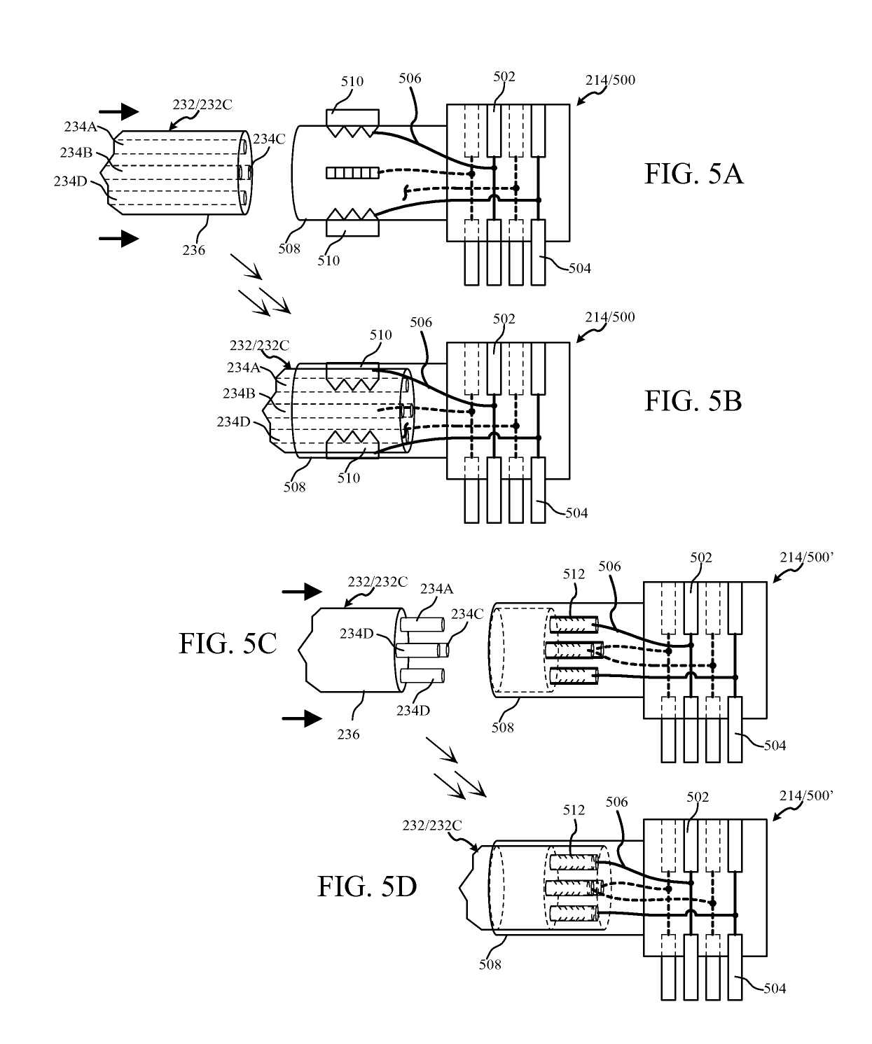

FIGS. 4 and 5 conceptually illustrate at least two options for press fit and crimping as may be employed in providing wiring harness 200. As shown more specifically in FIGS. 4A and 4B, for at least one embodiment, one or more plugs, such as plug 306A may have metal teeth 400 set to receive and bite into each wire 234 within wiring bundle 232 when wiring bundle 232 is inserted into the receiver section 308A of plug 306A. Again, based on either the alignment key—i.e., visual indicator 302 or cross section 304A (not shown in FIGS. 4 and 5) the alignment for coupling between the wiring bundle 232 and the plug 306 is properly ensured.

As shown in FIG. 4B, when the wiring bundle 232A is seated within the receiver section 308A, the metal teeth 400 make electrical contact with each intended wire 234. The metal teeth 400 may be crimped or otherwise depressed into the wiring bundle 232A to further establish a permanent attachment between plug 306A and wiring bundle 232A.

Indeed the teeth may be depressed at the same time the plug 306A is affixed to the wiring bundle 232A by squeezing with an appropriate tool, such as pliers, or depressed by radial squeezing as may be applied by tightening a band that is integral to or applied over the receiver section 308A and adjacent to the wiring bundle 232A.

Internal wiring 402 within plug 306A electrically interconnects each distinct wire 234 with a connector terminal 404 of the plug 306A. Although each connector terminal 404 may be male or female, for at least one embodiment, each plug 306 is female so as to reduce potentially exposed live contacts during the installation or maintenance of wiring harness 200.

As an alternative, for at least one embodiment as shown in FIGS. 4C and 4D, plug 306A′ may be configured with conductive internal teeth 406 set at an angle away from the receiver section 308A′. As such internal teeth 406 will deflect when and as a wire 234 is inserted, but bind firmly against each wire 234 when pulled backwards. This type of connection is quite common with electrical wall switches and electrical power outlets installed in homes as part of the existing wiring.

Moreover, for such an embodiment, at least a portion of the wiring bundle 232A covering 236 is stripped off prior to installation of the plug 306A so as to expose each of the wires 234 within the wiring bundle 232A. For example, about ¾″ may be exposed. For embodiments employing the physical key of the cross section 304A of the wiring bundle 232A, if the alignment is not correct, the exposed ends cannot be properly seated within the receiver section 308A of the plug 306A as the cross section 304A does not fit when misaligned.

When the alignment is correct the wiring bundle 232A can be properly disposed within the receiver section 308A of the plug 306A and the plug 306A attached. Enhanced attachment, and or assistance in press fitting the wiring bundle 232A into the receiver section 308A may is generally performed with a specific tool intended by the plug manufacturer for securing the plug 306A to the one or more wires inserted.

FIGS. 5A-5D are quite similar to FIGS. 4A-4D, however in these exemplary illustrations, plug 500 is an enlarged cross section of plug 214 shown in FIG. 2 as the plug for connection to existing outlet 230.

Moreover, plug 500 provides both female connectors 502 and male connectors 504 and internal wiring 506 within plug 500 interconnects female connectors 502 with male connectors 504 but also provides electrical interconnection to each of the wires 234 within wiring bundle 232 when disposed within the receiver section 508 of plug 500 and engaged by conductive metal teeth 510 as shown in FIGS. 5A and 5B, or conductive teeth 512 as shown in FIGS. 5C and 5D.

As with FIGS. 4A and 4B, FIGS. 5A and 5B illustrate an embodiment for plug 500 wherein wiring bundle 232 as a whole is press fit into the receiver section 508 of plug 500. Again, based on either the alignment key—i.e., visual indicator 302 or cross section 304A the alignment for coupling between the wiring bundle 232 and the plug 500 is properly ensured.

As shown in FIG. 5B, when the wiring bundle 232 is seated within the receiver section 308, the teeth 510 make electrical contact with each intended wire 234. The metal teeth 510 may be crimped or otherwise depressed into the wiring bundle 232 to further establish a permanent attachment between plug 500 and wiring bundle 232.

As an alternative, for at least one embodiment as shown in FIGS. 5C and 5D, plug 500′ may be configured with conductive internal teeth 512 set at an angle away from the receiver section 508′. As such metal teeth 512 will deflect when and as a wire 234 is inserted, but bind firmly against each wire 234 when pulled backwards. This type of connection is quite common with electrical wall switches and electrical power outlets installed in homes as part of the existing wiring.

Moreover, for such an embodiment, at least a portion of the wiring bundle 232 covering 236 is stripped off prior to installation of the plug 500′ so as to expose each of the wires 234 within the wiring bundle 232. For example, about ¾″ may be exposed. For embodiments employing the physical key of the cross section 304 of the wiring bundle 232, if the alignment is not correct, the exposed ends cannot be properly seated within the receiver section 308 of the plug 306 as the cross section 304 does not fit when misaligned.

When the alignment is correct the wiring bundle 232 can be properly disposed within the receiver section 508′ of the plug 500′ and the plug 500′ attached. Enhanced attachment, and or assistance in press fitting the wiring bundle 232 into the receiver section 508 may is generally performed with a specific tool intended by the plug manufacturer for securing the plug 500′ to the one or more wires inserted.

Once again it is to be understood and appreciated that the photovoltaic solar field 202 and wiring harness 200 are not a material drain on the house electrical system, but is rather a source of power providing electrical power into the buildings electrical system.

So as to alleviate the need for certified electricians for connection of appliances such as stoves, dryers, ovens, air conditioners or other 220 A/C appliances, most modern building construction includes at least one 30 AMP 220 A/C circuit. While it would be potentially harmful to place a splitter on such a 220 A/C outlet and attempt to drive two or more high current devices at the same time, this is not the case with the connection of a photovoltaic solar field 202 by plug and play wiring harness 200.

Indeed, so as to not disrupt the use of such a device, the present invention advantageously provides a connection plug 214/500 that is of a very special nature. This plug 214/500 provides both the male connectors 504 and female connectors 502. The male connectors 504 are as expected for the plug based connection of a 220 A/C device so that the solar photovoltaic solar field 202 by plug and play wiring harness 200 can be connected directly to the existing power outlet 230. The female connectors 502 advantageously permit plug 214/500 to receive the plug from an electric dryer, stove, oven, air conditioner or other device if such is desired to also be connected to the existing power outlet 230.

More specifically, the connection plug 214/500 of the wiring harness 200 of the present invention is advantageously configured to be placed between the plug of an existing appliance 222 and the existing wall outlet 230. Of course, if there is no existing appliance to be connected, the female portion of the plug is of no more concern then an existing wall outlet to which an electrical device may be connected. For at least one embodiment, the connection plug 214/500 may have a pigtail providing the female plug for receiving male plug from an existing appliance.

Moreover, with respect to the photovoltaic solar field 202 the existing outlet to which connection is made is perhaps more properly viewed as a power “inlet”—as power is being provided to the house system.

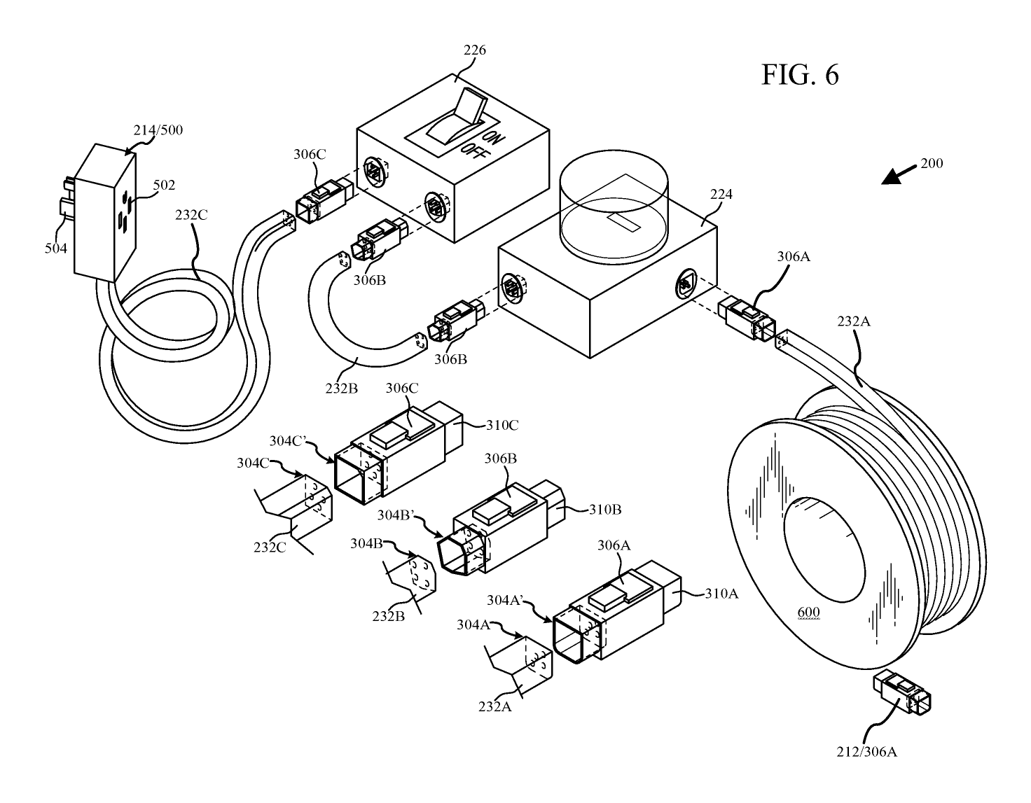

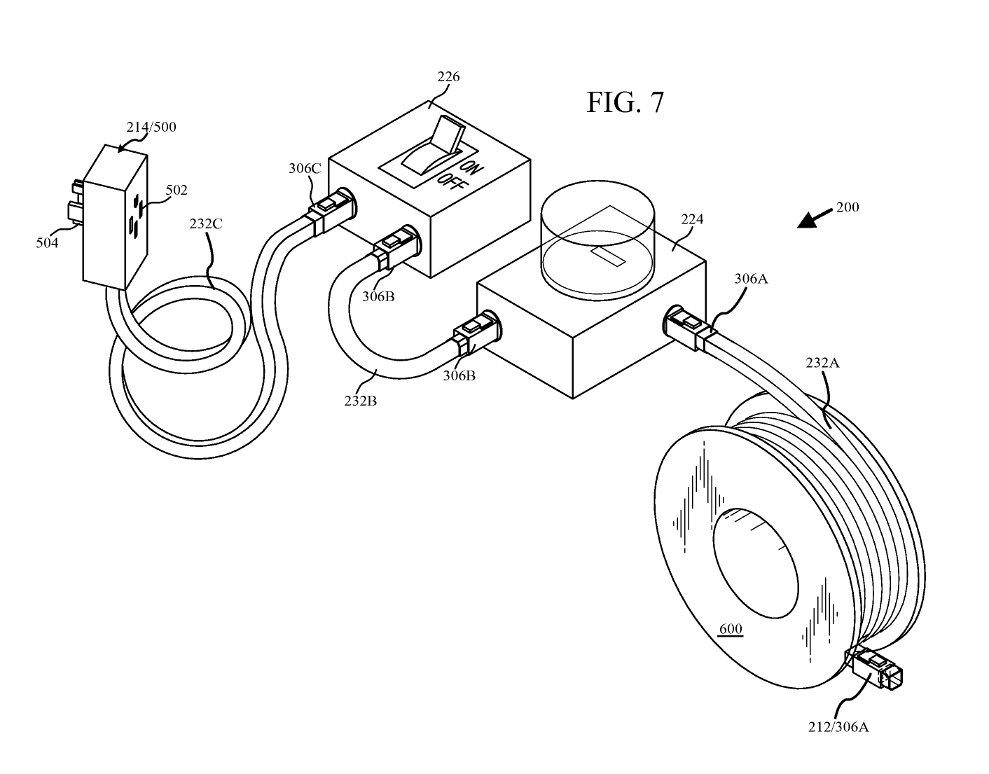

With the context of the above description, plug and play wiring harness 200 may also be further appreciated in FIGS. 6 and 7. As shown in FIG. 6 the elements of wiring harness 200 are entirely disconnected from each other. Continuing from the suggestion in FIG. 3, in FIG. 6 it may be more fully appreciated that wiring bundle 232A with a partial square cross section is set to couple through plug 306A to meter 224. As wiring bundle 232A is intended to connect with photovoltaic solar field 202 the excess wiring bundle 232A has been shown on spool 600.

Wiring bundle 232B which when assembled with end plugs 306B will interconnect the meter 224 with the disconnect 226, is also appreciated to have a distinct cross section 304B, and is also relatively short in comparison to wiring bundle 232A.

Wiring bundle 232C is shown with one end already attached to plug 214/500, which in the perspective view as presented is also more fully appreciated for the alignment of the female connectors and the mail connectors, permitting plug 214/500 to be disposed between an existing electrical appliance 222 and an existing outlet 230 on an existing circuit 220 as shown in FIG. 2.

FIG. 7 illustrates the same components of wiring harness 200 with the components assembled and interconnected. Moreover, wiring bundle 232A with plug 306A is shown coupled to meter 224. Wiring bundle 232B with plugs 306B is shown interconnecting the meter 224 and the disconnect 226, and wiring bundle 232C is shown coupled to the disconnect 226 and ready for connection by plug 214/500 to an existing outlet 230.

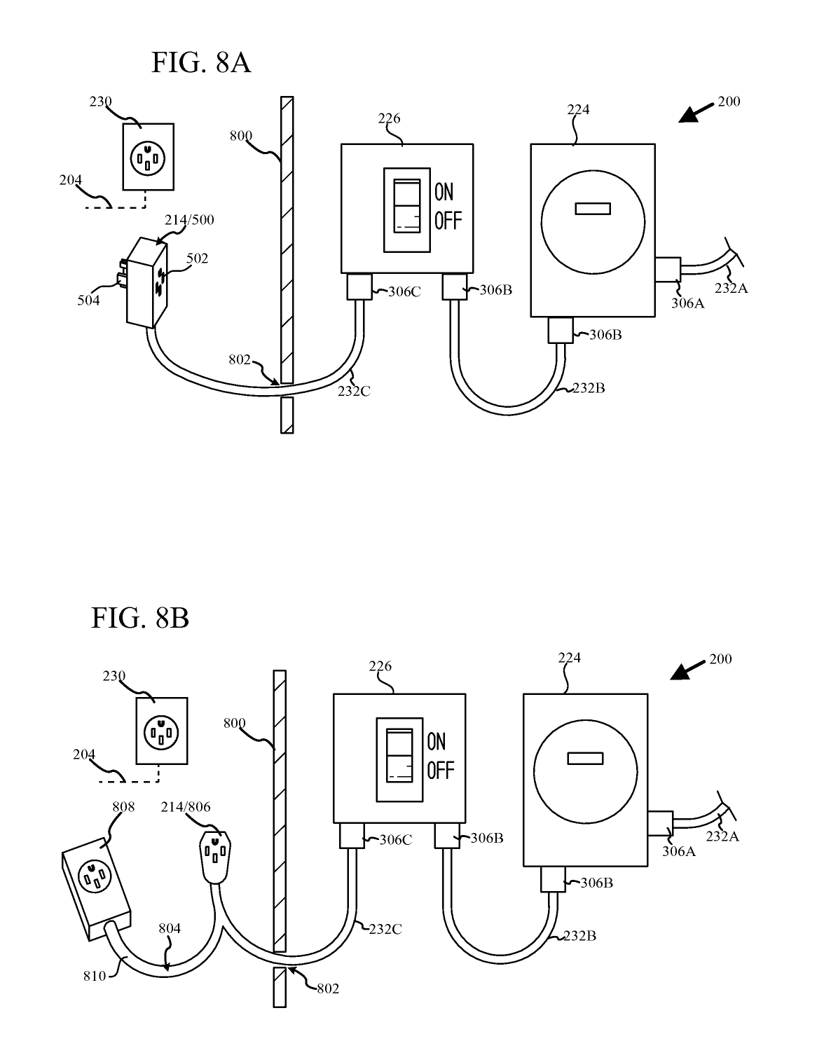

As typical existing 220 A/C outlets and plugs come in a variety of configurations and are typically quite large, for at least one embodiment the connection plug 214/500 to the existing building wiring is an element that is provided in the field. FIGS. 8A and 8B further conceptually illustrate how and why this is adventitious.

For both FIGS. 8A and 8B, the portion of the wiring harness 200 including the power meter 224 and the disconnect 226 are shown on the right to indicate that they are exterior to the house, illustrated as wall element 800. A small hole 802 appropriately sized to the diameter of the wiring bundle 232 is drilled in the side of the building, i.e. through the wall element 800 and the wiring bundle 232 itself is passed through the hole 802 to pass from the outside of the house to the inside of the house. The remaining gap between wiring bundle 232 and hole 802 is weather sealed.

Now provided to the inside of the building 206, the wiring bundle 232 is trimmed to an appropriate length so as to reach the intended existing outlet 230 in an appropriate and aesthetically pleasing manner. In other words, the wiring bundle 232 may be easily routed behind existing appliances, cabinets or the like so as to be visually unobtrusive and protected from accidental contact that might pull it loose from the intended existing outlet 230. An appropriate plug adapter is then selected, and because connection with the wiring bundle is dictated by the alignment key as discussed above, the proper alignment for connection is ensured.

With respect to the above description and accompanying figures, it is further understood and appreciated that for at least one embodiment wiring harness 200 is provided as a kit. More specifically, such a kit provides a wiring bundle 232 providing a plurality of electrically conductive wires 234 in a pre-defined arrangement, the wiring bundle 232 encased by a flexible non-conductive protective covering 236. The wiring bundle 232 has a first end and a second end; a first electrical plug 212 to be disposed upon a first end of the wiring bundle in a pre-determined alignment. The first electrical plug 212 providing at least one connector for each of the of the plurality of conductive wires 234 within the wiring bundle 232, the first electrical plug 212 structured and arranged to connect to a connector provided by the photovoltaic solar field 202 in only one orientation, the orientation ensuring proper electrical connection and alignment between the output lines of the photovoltaic solar installation and the wires 234 of the wiring bundle 232. At least one second electrical plug 214 to be disposed upon a second end of the wiring bundle 232 in a pre-determined alignment, the second electrical plug 214 providing at least one connector for each of the plurality of conductive wires within the wiring bundle 232. The second electrical plug 214 has a male connector with plurality of protruding electrical conductors for insertion into an existing outlet 230 and a female connector with inset electrical conductors to receive a plug intended for the existing power outlet 230.

This kit may indeed include a meter 224, a disconnect 226, and additional plugs as well as wiring bundles with different alignment keys so as to further ensure the proper wiring orientation is maintained from the photovoltaic solar field 202 to the point of connection with the existing electrical wiring 204 of a building 206.

Moreover, the plug and play wiring harness 200 is not a mere extension cord for it serves to provide multiple electrical devices between the photovoltaic solar field 202 and the buildings existing electrical wiring 204. Further, the use of a plug adapter having both male and female terminals permits connection of the wiring harness in an advantageously simple manner that is not at all obvious as a traditional outlet splitter for high current devices is typically highly discouraged.

For yet another embodiment as shown in FIG. 8B, plug 214 may be of a pigtail 804, providing one male plug element 806 for connection to the existing outlet 230 and a second female plug element 808 at the end of an additional wiring bundle 810 as the female outlet to receive the plug for an existing appliance desired for connection to existing outlet 230. Although the combined plug 500 may be simplest for most applications of wiring harness 200, in some situations the use of the pigtail 804 may be preferred for others.

In addition, although the above description has largely focused on the proper alignment of four wires for the connection of the photovoltaic solar field 202 to existing electrical wiring 204, for at least one embodiment the wiring harness 200 may provide an additional wire, and specifically an additional grounding wire. This additional wire may be connected to a grounding lug provided as part of the plug from the photovoltaic solar field 202 and intended for trunk line, i.e. wiring bundle 232A. As such, the metal frame of the rack providing support for the solar photovoltaic panels of the installation may be grounded to the grounding lug of the wiring harness. This additional wire may be further connected to a grounding lug adjacent to the next plug in the series intended for connection to the meter 224. From this second grounding lug a grounding wire run into the ground may be attached if and as desired.

In further addition, it is to be understood and appreciated that in addition to or in place of an additional grounding wire, for at least one embodiment, wiring harness 200 may comprise one or more wiring bundles 232 that have more than four wires intended for the transmission of electricity from the photovoltaic solar field 202 to the existing electrical wiring of the building 206.

To summarize in light of the above described materials, the of a plug and play electrical wiring harness 200 permitting connection of a photovoltaic solar field 202 to existing electrical wiring within a building is highly advantageous. Although useful in both commercial and residential solar photovoltaic system, the plug and play nature of the present invention is perhaps most advantageous with respect to the residential solar photovoltaic market.

With respect to the above description, it is also understood and appreciated that an advantageous method of providing a plug and play electrical wiring harness 200 permitting connection of a photovoltaic solar field 202 to existing electrical wiring 204 within a building 206 is also provided. It will be appreciated that the described events and method need not be performed in the order in which it is herein described, but that each of these descriptions is merely exemplary of varying methods of providing a plug and play electrical wiring harness 200 permitting connection of a photovoltaic solar field 202 to existing electrical wiring 204 within a building 206

Moreover, for at least one embodiment this method commences in general by measuring the wire run from the photovoltaic solar field 202 to a place of desired installation for the meter 224 and disconnect 226. A wiring bundle 232 of the determined length is then cut appropriately and fitted with plugs appropriate to connect the photovoltaic solar field 202 to the meter 224 that is installed on the side of the building 206. If not already installed, the disconnect 226 is then also installed and a second wiring bundle 232 is cut and fitted with appropriate plugs to interconnect the meter 224 and the disconnect 226.

An appropriate existing outlet 230 is identified in the building 206 and an appropriate whole is then drilled or otherwise established in a corresponding wall. A measurement is then made for this wiring run and an appropriate length of a wiring bundle 232 is then measured and cut. One end of this wiring bundle is fitted with an appropriate plug for connection to the disconnect 226 and the other end is passed through the hole to the inside of the building where it is then fitted with plug 214 for the existing outlet 230. A final visual inspection and or meter based connectivity test may be performed. Typically the disconnect 226 is placed in the OFF position before plug 214 is inserted into the existing outlet 230. If an existing appliance 222 is present it is then reconnected to plug 214.

Of course, as discussed above, each wiring bundle 232 and the associated plugs for each section of the wiring harness 200 may have a specific cross section 304 to key alignment as between each plug and its associated wiring bundle 232. Further, specific plugs 306 may be used so as to ensure that the order of components comprising wiring harness 200 is properly established.

By permitting the residential home owner or installer to quickly and easily connect the solar photovoltaic system to existing electrical wiring of a building, and to do so in compliance with existing code and approved plug devices, the costs associated with a certified electrician are avoided. Additional costs with respect to permits in some communities are also avoided as permits are not required for stoves, ovens, dryers or other devices connected directly to existing—and pre-certified electrical connectors.

It is to be understood that changes may be made in the above methods, systems and structures without departing from the scope thereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A plug and play style electrical wiring harness permitting connection of a photovoltaic solar installation to existing building wiring, comprising:
a wiring bundle providing a plurality of electrically conductive wires in a pre-defined arrangement, the wiring bundle encased by a flexible non-conductive protective covering, the wiring bundle having a first end and a second end;
a first electrical plug disposed upon the first end, the first electrical plug providing at least one connector for each of the of the plurality of conductive wires within the wiring bundle, the first electrical plug structured and arranged to connect to a connector provided by the photovoltaic solar installation in only one orientation, the orientation ensuring proper electrical connection and alignment between the output lines of the photovoltaic solar installation and the wires of the wiring bundle; and
a second electrical plug disposed upon the second end of the wiring bundle, the second electrical plug providing at least one connector for each of the plurality of conductive wires with the wiring bundle, the second electrical plug having a male connector with a plurality of protruding electrical conductors for insertion into an existing power outlet and a female connector with a plurality of inset electrical conductors to receive a conductor plug intended for the existing power outlet to which the male connector of the second plug is attached.

2. The plug and play style electrical wiring harness of claim 1, further including a disconnect device disposed between the first and second ends.

3. The plug and play style electrical wiring harness of claim 1, further including a net meter disposed between the first and second ends.

4. The plug and play style electrical wiring harness of claim 1, wherein the wiring bundle provides four conductive wires.

5. The plug and play style electrical wiring harness of claim 1, further including an additional ground wire in the wiring bundle.

6. The plug and play style electrical wiring harness of claim 1, wherein the wiring bundle has a pre-determined geometric cross section, normal to a length of the wiring bundle, the geometric cross section ensuring connection of the first plug to the wiring bundle in only one pre-defined alignment, and ensuring connection of the second plug to the wiring bundle in only one pre-defined alignment.

7. The plug and play style electrical wiring harness of claim 6, wherein the non-conductive protective covering further provides an alignment indicator to a user.

8. The plug and play style electrical wiring harness of claim 7, wherein the alignment indicator is at least one ridge.

9. The plug and play style electrical wiring harness of claim 7, wherein the alignment indicator is a visual indicator.

10. The plug and play style electrical wiring harness of claim 1, wherein the second plug has a plurality of pre-positioned conductive teeth structured and arranged to penetrate the non-conductive protective covering and couple to the each conductive wires within the wiring bundle, the conductive teeth electrically connecting the male and female connectors of the second electrical plug to the plurality wires of the wiring bundle in a pre-determined alignment.

11. The plug and play style electrical wiring harness of claim 1, wherein the second plug is structured and arranged for connection to an existing 220 AC outlet provided by the existing building wiring.

12. The plug and play style electrical wiring harness of claim 1, wherein the connection of the photovoltaic solar installation to the existing building wiring is performed in about the same plug and play style of connecting an electrical dryer to existing house wiring.

13. A plug and play style electrical wiring harness connecting a photovoltaic solar installation to existing building wiring, comprising:
a wiring bundle providing a plurality of electrically conductive wires in a pre-defined arrangement, the wiring bundle encased by a flexible non-conductive protective covering having an alignment key;
a first electrical plug disposed upon a first end of the wiring bundle in alignment with the alignment key, the first electrical plug structured and arranged to connect to a connector provided by the photovoltaic solar installation, the alignment with the alignment key ensuring proper electrical connection and alignment between output lines of the photovoltaic solar installation and the wires of the wiring bundle; and
a second electrical plug disposed upon a second end of the wiring bundle in alignment with the alignment key, the second electrical plug providing at least one connector for each of the plurality of conductive wires of the wiring bundle, the second electrical plug having a male connector with plurality of protruding electrical conductors for insertion into an existing power outlet and a female connector with a plurality of inset electrical conductors to receive an electrical plug intended for the existing power outlet to which the male connector of the second plug is attached.

14. The plug and play style electrical wiring harness of claim 13, further including a disconnect device disposed between the first and second ends.

15. The plug and play style electrical wiring harness of claim 13, further including a net meter disposed between the first and second ends.

16. The plug and play style electrical wiring harness of claim 13, wherein the mail connector and the female connector are on opposite sides of the second electrical plug.

17. The plug and play style electrical wiring harness of claim 13, wherein the wiring bundle provides four conductive wires.

18. The plug and play style electrical wiring harness of claim 13, further including an additional ground wire in the wiring bundle.

19. The plug and play style electrical wiring harness of claim 13, wherein the mail connector and the female connector are generally normal to each other on sides of the second electrical plug.

20. The plug and play style electrical wiring harness of claim 13, wherein the connection of the photovoltaic solar installation to the existing building wiring is performed in about the same plug and play style of connecting an electrical dryer to existing house wiring.

21. A plug and play style electrical wiring harness connecting a photovoltaic solar installation to existing building wiring, comprising:
at least a first, second and third wiring bundle each providing a plurality of electrically conductive wires in a pre-defined arrangement, each wiring bundle encased by a flexible non-conductive protective covering having an alignment key;
a first electrical plug disposed upon a first end of the first wiring bundle in alignment with the alignment key, the first electrical plug structured and arranged to connect to a connector provided by the photovoltaic solar installation, the alignment with the alignment key ensuring proper electrical connection and alignment between output lines of the photovoltaic solar installation and the wires of the first wiring bundle; and
a second electrical plug disposed upon a second end of the first wiring bundle in alignment with the alignment key, the second electrical plug providing at least one connector for each of the plurality of conductive wires of the first wiring bundle, the second electrical plug structured and arranged to connect to a first connector of a meter;
a third electrical plug disposed upon a first end of the first wiring bundle in alignment with the alignment key, the third plug providing at least one connector for each of the plurality of conductive wires within the second wiring bundle, the third electrical plug structured and arranged to connect to a second connector of the meter;
a fourth electrical plug disposed upon a second end of the second wiring bundle in alignment with the alignment key, the fourth plug providing at least one connector for each of the plurality of conductive wires within the second wiring bundle, the plurality of electrical plugs structured and arranged to connect to a first connector of a disconnect;
a fifth electrical plug disposed upon a first end of the third wiring bundle in alignment with the alignment key, the fifth plug providing at least one connector for each of the plurality of conductive wires within the third wiring bundle, the fifth electrical plug structured and arranged to connect to a second connector of the disconnect; and
a sixth electrical plug disposed upon a second end of the third wiring bundle in alignment with the alignment key, the sixth plug providing an electrical plug having a male connector with a plurality of protruding electrical conductors for insertion into an existing power outlet and a female connector with a plurality of inset electrical conductors to receive a plug intended for the existing power outlet.

22. The plug and play style electrical wiring harness of claim 21, wherein each wiring bundle has a pre-determined geometric cross section, normal to a length of the wiring bundle, the geometric cross section ensuring connection of the each plug to each associated wiring bundle in only one pre-defined alignment.

23. The plug and play style electrical wiring harness of claim 21, wherein the cross section of each wiring bundle is unique to ensure a fitting relationship with only the plugs associated with each wiring bundle.

24. The plug and play style electrical wiring harness of claim 21, wherein the wiring bundle provides four conductive wires.

25. The plug and play style electrical wiring harness of claim 21, further including an additional grounding wire in the wiring bundle.

26. The plug and play style electrical wiring harness of claim 21, wherein the mail connector and the female connector are generally normal to each other on sides of the second electrical plug.

27. The plug and play style electrical wiring harness of claim 21, wherein the connection of the photovoltaic solar installation to the existing building wiring is performed in about the same plug and play style of connecting an electrical dryer to existing house wiring.

28. A plug and play style electrical wiring harness kit permitting connection of a photovoltaic solar installation to existing building wiring, comprising:
a wiring bundle providing a plurality of electrically conductive wires in a pre-defined arrangement, the wiring bundle encased by a flexible non-conductive protective covering, the wiring bundle having a first end and a second end;
a first electrical plug to be disposed upon a first end of the wiring bundle in a pre-determined alignment, the first electrical plug providing at least one connector for each of the of the plurality of conductive wires within the wiring bundle, the first electrical plug structured and arranged to connect to a connector provided by the photovoltaic solar installation in only one orientation, the orientation ensuring proper electrical connection and alignment between the output lines of the photovoltaic solar installation and the wires of the wiring bundle; and
at least one second electrical plug to be disposed upon a second end of the wiring bundle in a pre-determined alignment, the second electrical plug providing at least one connector for each of the plurality of conductive wires within the wiring bundle, the second electrical plug having a male connector with plurality of protruding electrical conductors for insertion into an existing power outlet and a female connector with inset electrical conductors to receive a plug intended for the existing wire power outlet.

29. The plug and play style electrical wiring harness of claim 28, wherein providing a plug and play style electrical wiring harness for connection of a photovoltaic solar installation to existing building wiring comprises:
measuring the wiring bundle to determine an appropriate length to run from the photovoltaic solar installation to an existing electrical plug provided by the existing building wiring;
cutting the wiring bundle to the determined length;
disposing the first electrical plug upon a first end of the measured wiring bundle; and
disposing the second electrical plug upon a second end of the measured wiring bundle.

30. The plug and play style electrical wiring harness kit of claim 28, wherein the non-conductive protective covering has a pre-determined geometric cross section, normal to a length of the wiring bundle, the geometric cross section ensuring connection of the first plug to the wiring bundle in only one pre-defined alignment, and ensuring connection of the second plug to the wiring bundle in only one pre-defined alignment.

31. The plug and play style electrical wiring harness kit of claim 28, wherein the non-conductive protective covering further provides an alignment indicator to a user.

32. The plug and play style electrical wiring harness kit of claim 28, wherein the wiring bundle provides four conductive wires.

33. The plug and play style electrical wiring harness kit of claim 28, wherein the second plug has a plurality of pre-positioned conductive teeth structured and arranged to penetrate the non-conductive protective covering and couple to the plurality of conductive wires within the wiring bundle, the conductive teeth electrically connecting the male and female connectors of the second electrical plug to the plurality of wires of the wiring bundle in a pre-determined alignment.

34. The plug and play style electrical wiring harness of claim 28, wherein the second plug is structured and arranged for connection to an existing 220 AC outlet provided by the existing building wiring.

35. The plug and play style electrical wiring harness of claim 28, further including a disconnect device to be disposed between the first and second plugs.

36. The plug and play style electrical wiring harness of claim 28, further including a disconnect net meter device to be disposed between the first and second plugs.
